(19) United States
(12) Patent Application Publication
(10) Pub. No.: US 2003/0134943 A1
(43) Pub. Date: Jul. 17, 2003

(54) Method for preparing masterbatches based on polymers and mineral particles and resulting masterbatches

(76) Inventors: Dominique Labarre, Neuilly Sur Seine (FR); Helene Lanniois-Drean, Charenton Le Pont (FR); Patrick De Lanty, Bourg La Reine (FR); Martial Deruelle, Millery (FR)

Correspondence Address: John A Shedden, Intellectual Property Department, Rhodia Inc CN 7500, 259 Prospect Plains Road, Cranbury, NJ, 08512-7500, US

(21) Appl. No.: 10/181,616

(22) PCT Filed: Jan. 22, 2001
(86) PCT No.: PCT/FR01/00201

(30) Foreign Application Priority Data
Jan. 24, 2000 (FR) 00/01365

(51) Int. Cl. C08K 3/34

(52) U.S. Cl. 523/351; 524/492

(57) ABSTRACT

The invention concerns a method for preparing a masterbatch based on a polymer and mineral particles, in particular precipitate silica particles, by mixing a polymer dissolved in an organic solvent and mineral particles, in particular precipitate silica particles, suspended in an organic solvent. The invention also concerns masterbatch obtainable by said method.

The present invention relates to a method for preparing masterbatches based on at least one polymer and mineral particles and to the resulting masterbatches, which can be used for the preparation of rubber vulcanizates, especially within the context of the production of tyre covers, particularly the walls and above all the tread of a tyre, shoe soles, floor coverings, tubing, cables, drive belts, etc.

Attempts have been made for a long time to produce masterbatches based on a polymer and a filler, especially silica (U.S. Pat. Nos. 3,700,690 and 3,840,382).

At the present time, there are two broad ways of obtaining masterbatches.

The first way involves a so-called “physical” (or “dry” masterbatch) process; it consists of a simple operation of mechanically premixing the raw materials in an extruder or an internal mixer; this physical process, widely used in the plastics industry, is also used by certain rubber manufacturers for carbon-black-based mixtures.

The second way involves a so-called “wet” (or “wet” masterbatch) process; it consists in mixing the raw materials using an aqueous or organic solution of the polymer and an aqueous suspension of the filler, especially silica (U.S. Pat. Nos. 4,788,231, 5,763,388, WO 98/53004 and WO 99/15583), a coagulation step also very often being used.

However, the state of dispersion of the silica in the masterbatches obtained from the various coagulation methods is generally not very satisfactory and this means at the very least remixing these masterbatches in a Banbury-type internal mixer or an extruder having a dispersing power equivalent to this type of internal mixer.

In addition, the methods corresponding to this second way are preferential when using emulsion-polymerized elastomers; now, emulsion-synthesized elastomers generally consist of a latex of greater than one micron in size, that is to say a size very much greater than the theoretical distance separating two precipitated silica aggregates in an elastomer/precipitated silica masterbatch: the masterbatches therefore obtained will not have a homogeneous distribution (in terms of interparticle distance) or a good state of dispersion of the silica.

Finally, in the few methods making use of solution-polymerized elastomers, a step of mixing an organic solution (for the elastomer) with an aqueous suspension (for the silica, for example) is normally used, something which is hardly conducive to the homogeneity of the final product (flocculation and emulsion phenomena).

The object of the present invention is to provide an alternative to the known methods for preparing masterbatches, which preferably does not have the abovementioned drawbacks.

In addition, the vulcanizates obtained from the masterbatches that can be prepared by the method of the invention represent, without the use of a mixing step in an internal mixer, for example of the Banbury type, a highly satisfactory compromise of properties, especially mechanical, Theological and/or dynamic properties, this compromise generally being at least as good, especially in the case of the tensile properties, as the compromise of properties obtained for vulcanizates produced in the conventional way, comprising the mixing in an internal mixer of the polymer and the mineral particles.

Thus, the subject of the invention is a method for preparing a masterbatch based on at least one polymer and on mineral particles, which method is used to mix, generally with stirring:

at least one polymer in solution in an organic solvent, i.e. an organic polymer solution, with

mineral particles in suspension in an organic solvent, i.e. an organic suspension of mineral particles.

After the mixing operation, it is possible to remove the organic solvent(s) especially by drying or evaporation (for example by steam distillation). It is also possible to carry out a final forming step on the solid obtained.

In general, the mixing step is carried out at a temperature of between 10° C. and 80° C., for example between 15° C. and 35° C.

After the mixing operation, the organic solvent(s) may be recycled, after separation, to a step of preparing the organic polymer solution and/or to a step of preparing the organic suspension of mineral particles.

The organic polymer solution may come from dissolving the solid polymer in the organic solvent. However, it preferably comes from polymerizing the corresponding monomers in the organic solvent; preferably, one or more of the polymers obtained by solution polymerization is thus used in the method according to the invention.

In addition, the organic solvent in which the polymer is in solution is, advantageously, identical to the organic solvent in which the mineral particles are in suspension.

An organic suspension having a mineral particle content of between 1 and 30%, in particular between 5 and 20%, and for example between 5 and 15%, by mass is generally used.

Likewise, the polymer content of the organic solution employed is usually between 5 and 30% by mass.

The amounts of raw materials used are such that the masterbatch prepared contains, in general, from 10 to 150 parts, preferably from 25 to 100 parts and in particular from 40 to 75 parts, of mineral particles per 100 parts of polymer.

Within the context of the invention, the term “polymer” is also understood to mean “copolymer”.

The polymer used is in general an elastomer.

In general, it has at least a glass transition temperature of between −150° C. and +300° C., in particular between −150° C. and +20° C.

As possible polymers, mention may especially be made of diene polymers, particularly diene elastomers.

For example, mention may be made of natural rubber, polymers deriving from aliphatic or aromatic monomers containing at least one unsaturated group (such as, especially, ethylene, propylene, butadiene, isoprene and styrene), polybutyl acrylate, silicone elastomers, thermoplastic elastomers, functionalized elastomers, halogenated polymers and blends thereof.

The polymer employed may be EPDM. Preferably, an SBR (styrene-butadiene copolymer) and/or a BR (polybutadiene) is employed.

It is possible to use at least two different polymers.

The mineral particles used within the context of the invention are in general anionic. However, they may undergo, prior to their use, a surface treatment especially so as to make them cationic (cationization) for example by doping them with aluminium.

The mineral particles are usually chosen from the following group: silicas, particularly precipitated silicas, aluminas, aluminosilicates, titanium oxides, zinc oxides, calcium carbonates, calcium phosphates, zirconium phosphates, clays and hydrotalcites.

The mineral particles preferably used in the present invention consist of a filler which is known or can be used for the reinforcement of polymer compositions.

At least one organic, product providing the said mineral particles with a functionality may be added to the organic suspension of mineral particles, especially in the case of precipitated silica particles, before they are mixed with the organic polymer solution; in particular, a coupling agent, a coating agent and/or an anti-oxidant may be added; preferably, at least the coupling agent is added.

Advantageously, the organic suspension of mineral particles is prepared from an aqueous dispersion or suspension of the said mineral particles, by transferring the said mineral particles from the aqueous phase to the organic phase by means of at least one transfer agent.

More particularly, the suspension of mineral particles in an organic solvent is prepared as follows:

a) a water-immiscible organic solvent and a transfer agent, which is partially or preferably completely soluble in the said organic solvent, are mixed with an aqueous dispersion or suspension of mineral particles, the said transfer agent being added so as to reduce the hydrophilicity of the said mineral particles and thus to make them transfer (pass) into the said organic solvent;

b) the organic solvent containing the said mineral particles is separated from the aqueous phase.

Highly advantageously, the transfer is direct, that is to say it does not require a drying step.

In step a), the organic solvent may possibly be added first to the said aqueous dispersion or suspension and then the transfer agent may be added.

However, in step a) it is preferred instead to mix the aqueous dispersion or suspension of mineral particles with the water-immiscible organic solvent into which the transfer agent has been introduced beforehand; thus, prior to the mixing, the transfer agent is partially or preferably completely dissolved in the organic solvent.

The mixing operation of step a) is in general carried out with stirring.

The mineral particles pass from the aqueous phase into the organic phase by means of the transfer agent which attaches to the surface of the mineral particles.

The ionic force of the aqueous dispersion or suspension of mineral particles may vary, for example, between 0 and 3.

The organic solvent has rather a low polarity; it thus has, in the system proposed by C.M. Hansen, a polarity parameter δp which is usually less than 10 (J/cm³)^{1/2}, for example less than 7 (J/cm³)^{1/2}.

The aqueous dispersion or suspension of mineral particles generally has a pH corresponding to an optimal degree of coverage of the mineral particles with the transfer agent. Thus, the pH preferably lies between 3 and 11. It may lie, especially when the mineral particles are precipitated silica particles, between 7.5 and 10.5, for example between 8 and 10. The pH may lie between 3 and 5, especially when the mineral particles, for example precipitated silica particles, have undergone beforehand a cationization treatment.

Preferably, the transfer agent must be more soluble in the organic phase than in the aqueous phase.

The transfer agent normally used is a surfactant, especially an ionic or nonionic surfactant, preferably comprising at least two hydrophobic chains.

It is possible to use a cationic surfactant, for example when the mineral particles are anionic or if they have been made overall cationic by a specific treatment, when they still possess sufficient anionic sites. Thus, the transfer agent may be a quaternary amine or a quaternary amine salt. As examples of cationic surfactants, mention may be made of alkylammonium salts of formula R¹R²R³R⁴N⁺X⁻ in which:

X⁻ represents a halogen ion, CH₂SO₄⁻ or C₂H₅SO₄⁻;

R¹ and R² are identical or different and represent a C₁-C₂₀ alkyl radical or an aryl or benzyl radical;

R³ and R⁴ are identical or different and represent a C₁-C₂₀ alkyl radical, an aryl or benzyl radical, or an ethylene oxide and/or propylene oxide condensate (CH₂CH₂O)_{X}—(CH₂CHCH₃O)_{Y}—H, where x and y are between 0 and 30 and are never zero together.

Mention may especially be made of methyltrioctylammonium chloride.

An anionic surfactant can be used, for example when the mineral particles have been made overall cationic by a specific treatment (cationization), preferably by being doped with aluminium. As examples of anionic surfactants, mention may be made of:

alkyl ester sulphonates of formula R—CH(SO₃M)—COOR′, where R represents a C₈-C₂₀, particularly C₁₀-C₁₆, alkyl radical, R′ represents a C₁-C₆, particularly C₁-C₃, alkyl radical and M represents an alkali metal cation (especially sodium, potassium and lithium), substituted or unsubstituted ammonium (methylammonium, dimethyl ammonium, trimethylammonium, tetramethylammonium, dimethylpiperidinium, etc.) or a derivative of an akanolamine (monoethanolamine, diethanolamine, triethanolamine, etc.), the said alkyl ester sulphonates preferably being methyl ester sulphonates, the R radicals of which are C₁₄-Cl₆;

alkyl sulphates of formula ROSO₃M, where R represents a C₅-C₂₄, particularly C₁₀-C₁₈, alkyl or hydroxyalkyl radical, M representing a hydrogen atom or a cation as defined above, and their ethoxylated (EO) and/or propoxylated (PO) derivatives having, on average, between 0.5 and 30, particularly between 0.5 and 10, EO and/or PO units;

alkylamide sulphates of formula RCONHR′OSO₃M where R represents a C₂-C₂₂, particularly C₈-C₂₀, alkyl radical, R′ represents a C₂-C₃ alkyl radical, M represents a hydrogen atom or a cation as defined above, and their ethoxylated (EO) and/or propoxylated (PO) derivatives having, on average, between 0.5 and 60 EO and/or PO units;

salts of C₈-C₂₄, particularly C₁₄-C₂₀, saturated or unsaturated fatty acids, C₉-C₂O alkylbenzenesulphonates, C₈-C₂₂ primary or secondary alkyl sulphonates, alkyl glycerol sulphonates, sulphonated polycarboxylic acids, paraffin sulphonates, N-acyl-N-alkyltaurates, alkyl phosphates, alkyl isethionates, alkyl succinamates, alkyl sulphoxinates, monoesters or diesters of sulphoxinates, N-acylsarcosinates, sulphates of alkyl glycosides, polyethoxycarboxylates, the cation being an alkali metal (especially sodium, potassium or lithium), a substituted or unsubstituted ammonium (methylammonium, dimethylammonium, trimethylammonium, tetramethylammonium, dimethylpiperidinium) residue or a derivative of an alkanolamine (monoethanolamine, diethanolamine, triethanolamine, etc.).

Mention may especially be made of sodium dioctylsulphoxinate.

Optionally, a nonionic surfactant may be used; mention may especially be made of:

polyoxyalkylated (especially polyoxyethylated, polyoxypropylated or polyoxybutylated) alkylphenois, the alkyl substituent of which is C₆-Cl₂, containing between 5 and 25 alkylene units;

glucosamides, glucamides or glycerolamides;

polyoxyalkylated C₈-C₂₂ aliphatic alcohols containing between 1 and 25 oxyalkylene (especially oxyethylene and oxypropylene) units;

the products resulting from the condensation of ethylene oxide and the compound resulting from the condensation of propylene oxide with propylene glycol;

the products resulting from the condensation of ethylene oxide and the compound resulting from the condensation of propylene oxide with ethylenediamine;

polysiloxanes carrying polyether functional groups;

amine oxides, such as (C₁₀-C₁₈ alkyl)-dimethylamine oxides or (C₈-C₂₂ alkoxy)ethyldihyroxyethylamine oxides;

amides of C₈-C₂₀ fatty acids;

ethoxylated fatty acids;

ethoxylated fatty amides;

ethoxylated amines.

As nonionic surfactants, mention may be made of silanes (alkoxy silanes or chlorosilanes) having at least one hydrophobic hydrocarbon chain.

The transfer agent used may consist of a mixture containing, on the one hand, predominantly a nonionic surfactant and, on the other hand, an ionic surfactant.

In general, in step a) an amount of transfer agent is used which allows a monomolecular layer to be formed on the surface of the mineral particles. For example, especially in the case of an aqueous dispersion or suspension of precipitated silica having a pH of between 7.5 and 10.5, particularly between 8 and 10, the amount of transfer agent may be between 10 and 20%, particularly between 12 and 17%, by mass with respect to the mass of silica.

An aqueous dispersion or suspension may be used in step a) having a mineral particle content of between 1 and 30%, particularly between 5 and 15%, by mass.

Likewise, a volume of organic solvent is in general used in step a) such that the organic suspension of mineral particles obtained remains pourable after transfer.

A cosurfactant may possibly be used in addition to the transfer agent, especially in order to reduce the water/organic solvent interfacial tension; for example, a small amount of a heavy alcohol, such as octanol or nonanol, may be used.

Preferably, the state of dispersion of the mineral particles is at least as good in the organic solvent as in the starting aqueous phase.

The organic solvent containing the mineral particles, which is obtained from the aqueous dispersion or suspension of mineral particles may then optionally be subjected to an ultrasonic treatment.

The organic solvent(s) used within the context of the present invention is (are) chosen from aromatic hydrocarbons and aliphatic hydrocarbons which may be substituted. Mention may especially be made of xylene, benzene and toluene.

The mineral particles used in the invention are preferably precipitated silica particles. In particular, precipitated silica particles having a high dispersibility in a polymer medium, particularly in elastomers, are used.

As indicated above, the said precipitated silica may have undergone a cationization treatment, preferably by doping it with aluminium.

The aqueous dispersion or suspension of precipitated silica, from which the organic suspension of precipitated silica then used in the invention is preferably prepared, was preferably obtained during the method for preparing the said silica, the pH of the said suspension then possibly having been adjusted to a value making it possible to obtain the optimum level of covering of the mineral particles with the transfer agent. This pH value is preferably between 3 and 11. Thus, it may be between 7.5 and 10.5, for example between 8 and 10. It may also be between 3 and 5 when the precipitated silica has undergone a cationization treatment.

In addition, and this constitutes another advantage of the invention, this aqueous dispersion or suspension of precipitated silica was preferably obtained not only without using a drying step but without using a washing step and/or filtration step, steps which have a compacting action that most often is to the detriment of the final dispersibility of the silica in the polymer.

The aqueous dispersion or suspension of precipitated silica, from which the organic suspension of precipitated silica then used in the invention is preferably prepared, may derive from the methods described in applications EP 0520862, WO 95/09127, WO 95/09128 and WO 98/54090.

The precipitated silica particles that can be used within the context of the invention may have a CTAB specific surface area of between 40 and 400 m²/g, especially between 50 and 240 m²/g, particularly between 100 and 240 m²/g; thus, it may be between 140 and 240 m²/g, for example between 140 and 200 m²/g. The CTAB specific surface area is the external surface area determined according to the NF T 45007 standard (November 1987-5.12).

The masterbatches based on at least one polymer and on mineral particles, especially precipitated silica particles, that can be obtained by the method explained above constitute another subject of the present invention; preferably, the said masterbatches are in powder form.

Preferably, the mineral particles have a high dispersibility in the masterbatch obtained; in addition, this dispersibility is, advantageously, almost identical to that desired in the final vulcanizate.

The invention also relates to their use in a rubber vulcanizate and to the vulcanizates obtained from these masterbatches; any known vulcanization system can therefore be used. The vulcanizates obtained preferably have quite satisfactory properties.

The invention also relates to the finished articles based on the said masterbatches or on the said vulcanizates; as examples, mention may be made of tyre covers, particularly the walls and above all the treads of tyres, shoe soles, floor coverings, tubing, cables and drive belts.

Further advantages of the invention stem especially from the fact that it may make it possible, during the production of vulcanizates from masterbatches:

to significantly reduce the duration of the mixing step in the internal mixer, for example of the Banbury or Brabender type, hence resulting in a cost saving in mixing;

or even to eliminate this batch mixing step in an internal mixer, and therefore to achieve a continuous method, for example of the extruder type, therefore simplifying the method and increasing the capacity.

In addition, the thermal methods involved in the mixing step may therefore be at least limited. For example, in the case of precipitated silica, the latter already preferably being well dispersed in the polymer of the masterbatch, the energy conventionally needed to disperse it during the mixing step in the internal mixer is less; thus, this may now allow coupling agents to be used which hitherto were too reactive to the thermal fluctuations of the mixing step in an internal mixer.

Another subject of the invention is a method for preparing a suspension of mineral particles in an organic solvent from an aqueous dispersion or suspension of the said mineral particles, by transferring the said mineral particles from the aqueous phase into the organic phase by means of at least one transfer agent consisting of a nonionic surfactant or of a mixture containing, on the one hand, predominantly a nonionic surfactant and, on the other hand, an ionic surfactant. The conditions described in the above description for the preparation of the organic suspension of mineral particles, from an aqueous dispersion or suspension of mineral particles, within the context of the preparation of the masterbatch apply here.

The following examples illustrate the invention without, however, limiting the scope thereof.

### EXAMPLE 1

In this example, a suspension of 10% by mass of precipitated silica in xylene was prepared.

a) Firstly, an aqueous suspension of precipitated silica, corresponding to the stock of precipitated silica obtained just before the filtration/washing step in Example 1 of patent application EP 0520862, was used. This aqueous suspension contained 5.7% by mass of precipitated silica and had a pH of 5. The pH of this suspension was then adjusted to a value of 9 by adding 1M sodium hydroxide at room temperature.

b) Secondly, 3.8 g of methyltrioctylammonium chloride was mixed with 316.3 g of xylene.

c) Next, the solution obtained at b) was poured into a dropping funnel and then 620 g of the aqueous suspension obtained at a). The mixture obtained was stirred.

Steps b) and c) were carried out at room temperature.

It was found that the transfer of the precipitated silica from the aqueous phase to the organic phase was immediate.

Thus, 355.2 g of suspension containing 10% by mass of precipitated silica in xylene were recovered.

This organic suspension of precipitated silica was then subjected to an ultrasonic treatment in a Vibra Cell VC600 ultrasonic probe (sold by Sonics & Materials Inc.) fitted with a power-5 microprobe, the treatment being carried out continuously for 15 minutes, while preventing the organic suspension from being overheated.

The suspension containing 10% by mass of precipitated silica in xylene thus obtained is called S.

### EXAMPLE 2

a) 2.6 g of Si69, i.e. of bis(triethoxysilylpropyl)tetrasulphide (a filler/polymer coupling agent sold by Degussa), were added to 335.8 g of suspension S obtained from Example 1; the mixture obtained was stirred. The suspension thus prepared is called S1.

b) 350 g of an SBR elastomer (a styrene-butadiene copolymer) of the BUNA VSL 5525-0 type (sold by Bayer) were added to 1400 g of xylene; the mixture obtained was stirred in a closed container for about 48 hours. The solution containing 20% by mass of SBR in xylene thus prepared is called E.

c) 338.4 g of suspension S1 were mixed, with stirring, with 342.0 g of solution E.

d) The product obtained was then poured into a container so that there is a large area of contact with air favouring evaporation; the organic solvent was left to evaporate overnight under a hood.

Steps a) to d) were carried out at room temperature.

After step d), a masterbatch called M1 containing 50 parts by weight of precipitated silica and 4 parts by weight of Si69 coupling agent per 100 parts by weight of SBR was obtained.

### EXAMPLE 3

Masterbatch M1 and the following compounds (the proportions indicated are parts by weight per 154 parts by weight of masterbatch M1) were mixed on a roll mill:

| | |
|---|---|
| diphenylguanidine | 1.4 |
| stearic acid | 1.1 |
| zinc oxide | 1.8 |
| sulphenamide⁽¹⁾ | 1.3 |
| sulphur | 1.4 |

(⁽¹⁾: N-cyclohexyl-2-benzothiazyl sulphenamide).

The mixture obtained was then vulcanized at 170° C. for 40 minutes.

The vulcanizate thus prepared is called VM1.

### EXAMPLE 4

The mechanical properties, particularly the tensile properties (500 mm/min), of vulcanizate VM1 prepared from the masterbatch M1 without using a mixing step in an internal mixer were measured and compared with those of a vulcanizate, called V1, prepared conventionally, that is to say using a mixing step in an internal mixer.

a) Vulcanizate V1 was prepared as follows.

The elastomer composition below (the proportions indicated are parts by weight) was used:

| | |
|---|---|
| SBR⁽¹⁾ | 100 |
| precipitated silica⁽²⁾ | 50 |
| Si69 coupling agent | 4 |
| diphenylguanidine | 1.4 |
| stearic acid | 1.1 |
| zinc oxide | 1.8 |
| sulfenamide⁽³⁾ | 1.3 |
| sulphur | 1.4 |

⁽¹⁾: styrene-butadiene copolymer of the BUNA VSL 5525-0 type
⁽²⁾: precipitated silica obtained from Example 12 of patent application EP 0520862 (from the stock of precipitated silica obtained in Example 1 of patent application EP 0520862)
⁽³⁾: N-cyclohexyl-2-benzothiazyl sulphenamide.

This composition was prepared by applying thermomechanical work in an internal mixer, in two steps, with an average blade speed of 80 revolutions/minute, until a temperature of 120° C. at the end of each step was obtained, these steps being followed by a finishing step carried out on a roll mill.

The mixture obtained was then vulcanized at 170° C. for 40 minutes.

b) The properties of vulcanizates VM1 and V1 are given below, the measurements (moduli, elongation at break and tensile strength) having been carried out according to the NF T 46002 standard.

The x % moduli correspond to the stress measured at a tensile elongation of x %.

| | VM1 | V1 |
|---|---|---|
| 100% Modulus (MPa) | 2.9 | 3.2 |
| 300% Modulus (MPa) | 17 | 18 |
| Elongation at break (%) | 310 | 300 |
| Tensile strength (MPa) | 18 | 18 |

It may be seen that vulcanizate VM1 according to the invention represents a very satisfactory compromise of properties, although its preparation does not involve a mixing step in an internal mixer, unlike that of vulcanizate V1.

### EXAMPLE 5

a) 1.2 g of dynasilane, i.e. mercapto-propyltriethoxysilane (a filler/polymer coupling agent sold by Degussa), were added to 347.6 g of suspension S obtained from Example 1; the mixture obtained was stirred. The suspension thus prepared is called S2.

b) 348.8 g of suspension S2 were mixed, with stirring, with 349.0 g of solution E as prepared in Example 2.

c) The product obtained was then poured into a container so that there is a large area of contact with air favouring evaporation; the organic solvent was left to evaporate overnight under a hood.

Steps a) to c) were carried out at room temperature.

After step c), a masterbatch called M2 containing 50 parts by weight of precipitated silica and 1.8 parts by weight of dynasilane coupling agent per 100 parts by weight of SBR was obtained.

### EXAMPLE 6

Masterbatch M2 and the following compounds (the proportions indicated are parts by weight per 151.8 parts by weight of masterbatch M2) were mixed on a roll mill:

| | |
|---|---|
| diphenylguanidine | 1.4 |
| stearic acid | 1.1 |
| zinc oxide | 1.8 |
| sulphenamide⁽¹⁾ | 1.3 |
| sulphur | 1.4 |

(⁽¹⁾: N-cyclohexyl-2-benzothiazyl sulphenamide).

The mixture obtained was then vulcanized at 170° C. for 40 minutes.

The vulcanizate thus prepared is called VM2.

The mechanical properties, particularly the tensile properties (500 mm/min) of vulcanizate VM2 prepared from masterbatch M2 without using a mixing step in an internal mixer were measured.

These properties are given below, the measurements (moduli, elongation at break and tensile strength) having been carried out according to the NF T 46002 standard.

The x % moduli correspond to the stress measured for a tensile elongation of x %.

| | VM2 |
|---|---|
| 100% Modulus (MPa) | 2.8 |
| 300% Modulus (MPa) | 12.6 |
| Elongation at break (%) | 400 |
| Tensile strength (MPa) | 19 |

1. Method for preparing a masterbatch based on at least one polymer and on mineral particles, by mixing at least one polymer in solution in an organic solvent and mineral particles in suspension in an organic solvent.

2. Method according to claim 1, characterized in that, after mixing, the said organic solvent(s) is (are) removed.

3. Method according to claim 2, characterized in that a final forming step is then carried out on the solid obtained.

4. Method according to one of claims 1 to 3, characterized in that, after mixing, the said organic solvent(s) is (are) recycled for the preparation of the organic polymer solution and/or for the preparation of the organic suspension of mineral particles.

5. Method according to one of claims 1 to 4, characterized in that the organic solvent in which the polymer is in solution is identical to the organic solvent in which the mineral particles are in suspension.

6. Method according to one of claims 1 to 5, characterized in that the organic polymer solution comes from dissolving the solid polymer in an organic solvent or comes from polymerizing the corresponding monomers in an organic solvent.

7. Method according to one of claims 1 to 6, characterized in that the said polymer has at least a glass transition temperature of between −150° C. and +300° C., in particular between −150° C. and +20° C.

8. Method according to one of claims 1 to 7, characterized in that the said polymer is a diene polymer, preferably a diene elastomer.

9. Method according to one of claims 1 to 7, characterized in that the said polymer is chosen from natural rubber, polymers deriving from aliphatic or aromatic monomers containing at least one unsaturated group, polybutyl acrylate, silicone elastomers, thermoplastic elastomers, functionalized elastomers, halogenated polymers and blends thereof.

10. Method according to one of claims 1 to 7, characterized in that the said polymer is chosen from SBR, BR and EPDM.

11. Method according to one of claims 1 to 10, characterized in that two different polymers are used.

12. Method according to one of claims 1 to 11, characterized in that the mineral particles are chosen from the following group: silicas, aluminas, aluminosilicates, titanium oxides, zinc oxides, calcium carbonates, calcium phosphates, zirconium phosphates, clays and hydrotalcites.

13. Method according to one of claims 1 to 12, characterized in that the mineral particles consist of a filler for the reinforcement of polymer compositions.

14. Method according to one of claims 1 to 13, characterized in that at least one organic product providing the said mineral particles with a functionality is added to the organic suspension of mineral particles before they are mixed with the organic polymer solution.

15. Method according to claim 14, characterized in that at least one coupling agent, at least one coating agent and/or at least one antioxidant are added to the organic suspension of mineral particles before they are mixed with the organic polymer solution.

16. Method according to one of claims 1 to 15, characterized in that the suspension of mineral particles in an organic solvent is prepared from an aqueous dispersion or suspension of the said mineral particles, by transferring the said mineral particles from the aqueous phase to the organic phase by means of at least one transfer agent.

17. Method according to claim 16, characterized in that the suspension of mineral particles in an organic solvent is prepared as follows:
a) a water-immiscible organic solvent and a transfer agent, which is partially or completely soluble in the said organic solvent, are mixed with an aqueous dispersion or suspension of mineral particles, the said transfer agent being added so as to reduce the hydrophilicity of the said mineral particles and to make them transfer into the said organic solvent;
b) the organic solvent containing the said mineral particles is separated from the aqueous phase.

18. Method according to either of claims 16 and 17, characterized in that the said aqueous dispersion or suspension of mineral particles has a pH of between 3 and 11.

19. Method according to either of claims 17 and 18, characterized in that the said transfer agent is a surfactant.

20. Method according to one of claims 17 to 19, characterized in that the said transfer agent is an ionic surfactant.

21. Method according to claim 20, characterized in that the said transfer agent is a cationic or anionic surfactant.

22. Method according to claim 21, characterized in that the said transfer agent is a quaternary amine or a quaternary amine salt.

23. Method according to one of claims 17 to 19, characterized in that the said transfer agent is a nonionic surfactant.

24. Method according to one of claims 1 to 23, characterized in that the said organic solvent(s) is (are) chosen from aromatic hydrocarbons and aliphatic hydrocarbons which may be substituted.

25. Method according to claim 24, characterized in that the said organic solvent(s) is (are) chosen from xylene, benzene and toluene.

26. Method according to one of claims 16 to 25, characterized in that the said mineral particles are precipitated silica particles.

27. Method according to claim 26, characterized in that the aqueous dispersion or suspension of precipitated silica used was obtained during the method for preparing the said silica, the pH of the said suspension then possibly having been adjusted to a value of between 7.5 and 10.5, particularly between 8 and 10.

28. Method according to claim 26, characterized in that the said precipitated silica has undergone a cationization treatment, preferably by doping it with aluminium.

29. Method according to claim 28, characterized in that the aqueous dispersion or suspension of precipitated silica used was obtained during the method for preparing the said silica, the pH of the said suspension then possibly having been adjusted to a value of between 3 and 5.

30. Method according to either of claims 27 and 29, characterized in that the said aqueous dispersion or suspension of precipitated silica was obtained without using a washing and/or filtration step.

31. Method for preparing a suspension of mineral particles in an organic solvent from an aqueous dispersion or suspension of the said mineral particles, by transferring the said mineral particles from the aqueous phase to the organic phase by means of at least one transfer agent consisting of a nonionic surfactant or of a mixture containing, on the one hand, predominantly a nonionic surfactant and, on the other hand, an ionic surfactant.

32. Method according to claim 31, in which:
a) a water-immiscible organic solvent and the said transfer agent, which is partially or completely soluble in the said organic solvent, are mixed with an aqueous dispersion or suspension of mineral particles, the said transfer agent being added so as to reduce the hydrophilicity of the said mineral particles and to make them transfer into the said organic solvent;
b) the organic solvent containing the said mineral particles is separated from the aqueous phase.

33. Masterbatch based on at least one polymer and on mineral particles, especially precipitated silica particles, that can be obtained by the method according to claims 1 to 30.

34. Use of a masterbatch defined in claim 33 in a rubber vulcanizate.

35. Vulcanizate obtained from the masterbatch defined in claim 33, preferably without the use of mixing in an internal mixer.

36. Finished article based on a masterbatch defined in claim 33 or based on a vulcanizate defined in claim 35.

37. Finished article according to claim 36, consisting of a tyre cover, particularly of a tyre tread.
